(19) United States
(12) Patent Application Publication
(10) Pub. No.: US 2023/0182234 A1
(43) Pub. Date: Jun. 15, 2023

(54) PROCESSING OPTICAL UNIT, LASER PROCESSING APPARATUS AND METHOD FOR LASER PROCESSING

(71) Applicant: TRUMPF Laser- und Systemtechnik GmbH, Ditzingen (DE)

(72) Inventors: Daniel Flamm, Ludwigsburg (DE); Julian Hellstern, Rottweil (DE); Jonas Kleiner, Leonberg (DE); Malte Kumkar, Weimar (DE); Marcel Schaefer, Burladingen (DE)

(21) Appl. No.: 18/067,746

(22) Filed: Dec. 19, 2022

Related U.S. Application Data
(63) Continuation of application No. PCT/EP2021/064611, filed on Jun. 1, 2021.

(30) Foreign Application Priority Data
Jun. 22, 2020 (DE) 10 2020 207 715.0

(51) Int. Cl. B23K 26/067; B23K 26/064

(52) U.S. Cl. CPC B23K 26/0673; B23K 26/064

(57) ABSTRACT

A processing optical unit for workpiece processing includes a polarizer arrangement comprising a birefringent polarizer element for splitting at least one input laser beam into at least two partial beams each partial beam having one of two different polarization states, and a focusing optical unit arranged downstream of the polarizer arrangement in the beam path and configured to focus the partial beams onto at least two focus zones. The polarizer arrangement has a further optical element arranged downstream of the birefringent polarizer element in the beam path and configured to change an angle and/or a distance of at least one of the partial beams relative to an optical axis of the processing optical unit.

### CROSS REFERENCE TO RELATED APPLICATIONS

This application is a continuation of International Application No. PCT/EP2021/064611 (WO 2021/259597 A1), filed on Jun. 1, 2021, and claims benefit to German Patent Application No. DE 10 2020 207 715.0, filed on Jun. 22, 2020 The aforementioned applications are hereby incorporated by reference herein.

### FIELD

The present invention relates to a processing optical unit for workpiece processing, in particular by means of an ultrashort pulse laser source, comprising: a polarizer arrangement comprising a birefringent polarizer element for splitting at least one, in particular pulsed, input laser beam into at least two partial beams each having one of two different polarization states, and a focusing optical unit arranged downstream of the polarizer arrangement in the beam path and serving for focusing the partial beams onto at least two focus zones. The invention also relates to a laser processing apparatus comprising such a processing optical unit, and to a method for the laser processing of a workpiece by means of a processing optical unit, comprising: splitting at least one, in particular pulsed, input laser beam into at least two partial beams, each having one of two different polarization states, at a birefringent polarizer element of a polarizer arrangement, and focusing the partial beams onto focus zones in the region of the workpiece by means of a focusing device of the processing optical unit.

### BACKGROUND

Within the meaning of this application, partial beams having different polarization states are understood to mean linearly polarized partial beams whose polarization directions are oriented at an angle of 90° to one another. However, partial beams having different polarization states are also understood to mean circularly polarized partial beams having an opposite rotation sense, i.e. two left and respectively right circularly polarized partial beams. The conversion of linearly polarized partial beams having polarization directions oriented perpendicularly to one another into circularly polarized partial beams having an opposite rotation sense can be effected e.g. with the aid of a suitably oriented retardation plate (λ/4 plate).

During the laser processing of a workpiece, in particular during laser ablation, laser cutting, surface structuring, laser welding, laser drilling, etc., it is expedient to split an input laser beam into a plurality of partial beams which impinge or are focused on the workpiece at different positions. The splitting can be effected at a polarizer element, wherein generally two partial beams each having one of two different polarization states, e.g. two partial beams polarized perpendicularly to one another, are formed as output laser beams from one input laser beam. It is possible for a plurality of input laser beams that are spatially offset or have an angle offset to impinge on the polarizer element. In this case, each of the input laser beams can be split into a pair of partial beams each having one of two different polarization states. Whether or with what power proportions the two partial beams are formed is dependent on the polarization of the input laser beam.

WO2015/128833A1 describes a laser cutting head having a polarizing beam offset element for producing two linearly polarized partial beams, said beam offset element being arranged in the beam path of a laser beam. The polarizing beam offset element is arranged in a divergent or in a convergent beam path section of the laser beam. The beam offset element can be formed from a birefringent material. With the use of a focusing, magnifying optical unit and a beam offset element arranged downstream of the focusing optical unit in the beam path, the two partial beams can be partly superimposed in the focal plane.

WO2015/5114032 A1 has disclosed a laser processing apparatus for workpiece processing comprising a processing optical unit, wherein an input laser beam is split into two perpendicularly polarized partial beams at a polarizer. The processing optical unit has a longer path length for the second partial beam than for the first partial beam, as a result of which the second partial beam has a longer propagation time than the first partial beam. The second partial beam is altered in at least one geometric beam property vis-à-vis the first partial beam. The altered second partial beam is superimposed on the first partial beam in such a way that both partial beams form a common output laser beam.

WO2018/020145A1 describes a method for cutting dielectric or semiconductor material by means of a pulsed laser, wherein a laser beam is split into two partial beams, which impinge on the material in two spatially separated zones offset by a distance with respect to one another. The distance is set to a value below a threshold value in order to produce in the material a rectilinear micro-fracture running in a predefined direction between the two mutually offset zones. Beam shaping can be carried out on the two partial beams in order to produce a spatial distribution on the material in the form of a Bessel beam.

WO2016/089799A1 describes a system for the laser cutting of at least one glass article by means of a pulsed laser assembly comprising a beam-shaping optical element for converting an input beam into a quasi-nondiffractive beam, for example a Bessel beam. The laser assembly also comprises a beam transformation element for converting the quasi-nondiffractive beam into a plurality of partial beams spaced apart from one another by between 1 µm and 500 µm. The phase of at least one of the quasi-nondiffractive partial beams can be shifted between approximately π/4 and approximately 2 π.

DE 10 2019 205 394.7 describes a processing optical unit for workpiece processing comprising a birefringent polarizer element for splitting at least one input laser beam into a pair of partial beams polarized perpendicularly to one another, and also a focusing optical unit arranged downstream of the polarizer element in the beam path and serving for focusing the partial beams onto focus zones, wherein the processing optical unit is configured for producing at least partly overlapping focus zones of the partial beams polarized perpendicularly to one another. The processing optical unit can be configured for producing a plurality of pairs of at least partly overlapping focus zones along a predefined contour in a focal plane, wherein focus zones of in each case two partial beams polarized perpendicularly to one another of directly adjacent pairs at least partly overlap one another.

### SUMMARY

In an embodiment, the present disclosure provides a processing optical unit for workpiece processing includes a polarizer arrangement comprising a birefringent polarizer element for splitting at least one input laser beam into at least two partial beams each partial beam having one of two different polarization states, and a focusing optical unit arranged downstream of the polarizer arrangement in the beam path and configured to focus the partial beams onto at least two focus zones. The polarizer arrangement has a further optical element arranged downstream of the birefringent polarizer element in the beam path and configured to change an angle and/or a distance of at least one of the partial beams relative to an optical axis of the processing optical unit.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1a,1b and 1c show schematic illustrations of three birefringent polarizer elements for producing an angle offset without position offset, a position offset without angle offset, and also a position offset and an angle offset between two partial beams having different polarization states;

FIGS. 2a and 2b show schematic illustrations of a polarizer arrangement comprising a birefringent polarizer element and an isotropic optical element for aligning one of the two partial beams parallel to the optical axis;

FIGS. 3a,3b and 3c how schematic illustrations of a polarizer arrangement comprising a birefringent polarizer element and comprising further optical elements for positioning one of the two partial beams on the optical axis or for positioning both partial beams at identical distances from the optical axis;

FIG. 4 shows a schematic illustration of a polarizer arrangement comprising a birefringent polarizer element and comprising a further birefringent optical element for forming two partial beams which intersect at a predefined distance from the polarizer arrangement;

FIGS. 5a, 5b and 5c show schematic illustrations of a polarizer arrangement comprising a birefringent polarizer element and comprising a further birefringent optical element, which is rotatable about the optical axis and/or displaceable along the optical axis in order to change a position offset and/or an angle offset between the two partial beams;

FIGS. 6a and 6b show schematic illustrations of the position offset produced by the polarizer arrangement from FIG. 5a, and respectively the angle offset produced by the polarizer arrangement from FIG. 5b, as a function of the rotation angle of the further birefringent optical element;

FIGS. 7a and 7b show schematic illustrations of a processing optical unit comprising a beam shaping optical unit for forming two partly overlapping partial beams having a Bessel-shaped beam profile and also comprising a polarizer arrangement in accordance with FIG. 2a for producing an angle offset and respectively comprising a polarizer element in accordance with FIG. 1b for producing a position offset between the two partial beams, and

FIGS. 8a, 8b and 8c show a schematic illustration of a processing optical unit comprising a beam shaping optical unit and also comprising an interaction region with two partly overlapping partial beams having a position offset, and respectively a processing optical unit having a polarizer arrangement in accordance with FIG. 2a and respectively in accordance with FIG. 3c.

### DETAILED DESCRIPTION

An aspect of the present invention is to provide a processing optical unit, a laser processing apparatus therewith and a method for laser processing which make it possible to align the partial beams in the focus zones at defined angles and/or positions with respect to the optical axis of the processing optical unit.

According to one aspect, the present invention provides a processing optical unit of the type mentioned in the introduction wherein the polarizer arrangement has at least one further optical element arranged downstream of the birefringent polarizer element in the beam path and serving for changing an angle and/or a distance of at least one of the partial beams relative to an optical axis of the processing optical unit.

When the input laser beam is split into the at least two partial beams at the or at a single birefringent polarizer element, it may not be possible to produce that distance and/or that alignment of the partial beams relative to the optical axis of the processing optical unit which are/is intended to be produced when the partial beams are focused onto the focus zones. This is attributable to the fact that generally a predefined position and/or angle offset of the two partial beams relative to one another and a desired angle and/or a desired position in relation to the optical axis of the processing optical unit cannot be produced simultaneously by means of one and the same polarizer element. In order to achieve both, it is proposed to arrange at least one further optical element downstream of the birefringent polarizer element in the beam path.

The input laser beam generally impinges on the birefringent polarizer element parallel to the optical axis, in particular along the optical axis of the processing optical unit. In principle, however, it is also possible to set or predefine the alignment and/or the position of the input laser beam relative to the optical axis by means of one or more optical elements arranged upstream of the polarizer element in the beam path.

Even though only one polarizer arrangement having one birefringent polarizer element for the splitting into two partial beams is described in the following description, in principle two or more birefringent polarizer elements can also be provided in the processing optical unit. By way of example, in this case, the laser beam which is generated by a laser source and enters the processing optical unit can be split into two or more partial beams, which each constitute an input laser beam for an associated birefringent polarizer element, or the laser beams of a plurality of laser sources can be used as input laser beams.

In one embodiment, the polarizer element is configured for producing a position offset and/or an angle offset between the partial beams having the different polarization states. Generally, when the input beam is split into the at least two partial beams at a birefringent polarizer element, a lateral offset (position offset) and/or an angle offset between the two partial beams are/is produced. The birefringent polarizer element can be configured either for producing a lateral (position) offset or for producing an angle offset or for producing a combination of an angle offset and a position offset between the two partial beams having the different polarization states.

With the aid of a birefringent polarizer element, typically in the form of a birefringent crystal, given suitable polarization of the input laser beam, e.g. given an unpolarized input laser beam or given an input laser beam having undefined, elliptical or circular polarization, the targeted spatial splitting of the input laser beam into its polarization constituents is made possible. The splitting of the power of the input laser beam between the two partial beams is dependent on the polarization of the input laser beam or can be defined by the choice of the polarization of the input laser beam: If the polarization of the input laser beam is linear or has some other preferred direction, e.g. in the case of elliptical polarization, the power of the input laser beam is typically not split uniformly between the two partial beams.

It may be expedient to influence the polarization of the input laser beam with the aid of suitable polarization-influencing optical elements, for example in the form of retardation plates, in order to influence in a targeted manner the splitting ratio during the splitting of the input laser beam into the two partial beams and optionally to switch the splitting of the input laser beam into the two partial beams on or off. If the input laser beam is circularly polarized, splitting of the power of the input laser beam between two partial beams with comparable power proportions can be achieved independently of the angle of a preferred direction possibly present during the processing (see below).

Depending on the configuration of the birefringent polarizer element, a well-defined, pure position offset, a well-defined, pure angle offset or a combination of a defined position offset and a defined angle offset can be produced between the two partial beams having the different polarization states.

In order to produce the position offset (without an angle offset), the birefringent polarizer element can have for example generally planar beam entrance and beam exit surfaces aligned parallel. In this case, the optical axis of the birefringent crystal is typically oriented at an angle with respect to the beam entrance surface. If the input laser beam impinges on the beam entrance surface perpendicularly, a pure position offset is produced at the beam exit surface.

In order to produce the angle offset (without a position offset), the birefringent polarizer element can have a beam exit surface that is inclined at an angle with respect to the beam entrance surface. In this case, the optical axis of the birefringent crystal is typically aligned parallel to the beam entrance surface. In this case, at the beam exit surface, the two partial beams emerge from the birefringent crystal at the same position and with a defined angle offset.

In order to produce a position and angle offset, the birefringent polarizer element can have a beam exit surface that is inclined at an angle with respect to the beam entrance surface. In this case, the optical axis of the birefringent crystal is typically oriented at an angle with respect to the beam entrance surface and with respect to the beam exit surface. A birefringent polarizer element which produces a pure position offset and a birefringent polarizer element which produces a pure angle offset constitute special cases of the birefringent polarizer element described here, which produces both an angle offset and a position offset.

In one development, the polarizer element is configured for producing an angle offset between the partial beams having the different polarization states, and the further optical element is configured to change the angle of at least one of the two partial beams relative to the optical axis in order to align the at least one partial beam parallel to the optical axis. An alignment of (at least) one of the partial beams parallel to the optical axis is advantageous in particular if the polarizer element or the polarizer arrangement is rotated about the optical axis in order to change a preferred direction during the processing of the workpiece. Such an alignment makes it possible to avoid an undesired offset of said partial beam dependent on the rotation angle of the polarizer element about the rotation axis, or to produce a constant offset about the optical axis during the rotation of the partial beam.

In one development, the further optical element is configured in an optically isotropic fashion, wherein the polarizer element is preferably configured for producing an angle offset without producing a position offset. In this case, the further optical element is preferably configured as a wedge-shaped optically isotropic element. In this case, the wedge angle of the wedge-shaped further optical element is typically adapted to a wedge angle of the exit surface of the polarizer element in order to compensate for the angle offset of one of the two partial beams or in order to form the average of the angle offset for both partial beams relative to the optical axis. Generally, by means of a suitable coordination of the wedge angle of the wedge-shaped further optical element and the wedge angle of the birefringent polarizer element, a desired distance or offset between the parallel aligned partial beam and the optical axis can be predefined, which is maintained during the rotation about the rotation axis.

Through the use of a wedge-shaped optical element having two wedge angles that are in planes perpendicular to one another, the two focus zones produced after passage through the focusing optical unit can additionally impose an angle (which is identical for both partial beams) in a direction perpendicular to the plane of incidence or to the plane in which the optical axis of the birefringent polarizer element is arranged. After the Fourier transformation by the focusing optical unit, the imposed angle is converted into a position offset in the focal plane. Given a suitable distance between the polarizer arrangement and the focusing optical unit, the two partial beams can pass in the focal plane parallel to the optical axis and be positioned at the same distance from the optical axis.

In one development, the polarizer arrangement has a beam offset optical unit comprising a further birefringent optical element in order to align both partial beams parallel to one another. An additional optical element embodied for example as a wedge-shaped optical element and arranged downstream of the further birefringent optical element in the beam path can change the beam direction of the two parallel aligned partial beams, such that both partial beams are aligned parallel to the optical axis. By setting the distance between the further birefringent element and the additional optical element of the beam offset optical unit in the direction of the optical axis, it is possible to define the distance between the two partial beams and the optical axis.

In one development, the polarizer arrangement is configured to position one of the partial beams on the optical axis or to position both partial beams at identical distances from the optical axis. Particularly when the polarizer element is rotated about the optical axis of the processing optical unit (Z-direction), it has proved to be advantageous if one of the two partial beams is positioned on the optical axis of the processing optical unit, such that the position of said partial beam does not change during the rotation. A symmetrical arrangement of the two partial beams in relation to the optical axis, wherein both partial beams are arranged at identical distances from the optical axis, is also possible. There are a number of possibilities for positioning the partial beam on the optical axis or the two partial beams symmetrically with respect to the optical axis:

One possibility consists, in the case of the beam offset optical unit described above, in predefining the distance between the further birefringent optical element and the additional optical element along the optical axis or optionally setting it by means of a suitable displacement device such that one of the two partial beams passes along the optical axis of the processing optical unit and the other partial beam passes in a manner offset with respect to the optical axis or that both partial beams pass at the same distance with respect to the optical axis.

In a further development, the birefringent polarizer element is configured for producing a position offset in addition to producing the angle offset, and the further optical element is configured in a birefringent fashion in order to position the partial beam on the optical axis. In this case, the optical axis of the birefringent material of the polarizer element and also the beam entrance surface thereof and the beam exit surface thereof are aligned and arranged at a distance with respect to the further birefringent element such that one of the two partial beams is aligned parallel to the optical axis and is positioned on the optical axis of the processing optical unit.

In a further development, the polarizer arrangement is configured to change the angle offset and/or position offset between the two partial beams. The angle offset and/or position offset between the two partial beams as produced by the polarizer element are/is - under predefined boundary conditions - typically constant. In order to change the angle offset and/or position offset produced by the polarizer arrangement, the or at least one further generally birefringent optical element is provided in the polarizer arrangement and makes it possible to change or to set the angle offset and/or the position offset between the two partial beams. For this purpose, the further, generally birefringent optical element is typically movable relative to the optical axis of the polarizer arrangement.

In one development of this embodiment, the further optical element is configured in a birefringent fashion and, for the purpose of changing the angle offset and/or for the purpose of changing the position offset between the two partial beams, is displaceable along the optical axis of the processing optical unit and/or is rotatable about the optical axis of the processing optical unit. For displacing the further birefringent optical element along the optical axis, use can be made of a translation drive, which can be configured for example in the manner of a linear drive or the like. For the rotation of the further optical element about the optical axis of the polarizer arrangement, the polarizer arrangement typically has a rotary drive. A control device of the processing optical unit or a device connected thereto in terms of signaling, for example a control computer, can be used for controlling the translation drive and/or the rotary drive. With the use of such a polarizer arrangement, the distance between the focus zones of the two partial beams in the region of the workpiece can be set to a desired value.

In a further embodiment, the further optical element is configured in a birefringent fashion, and a polarization-influencing optical element, in particular a λ/4 retardation plate or a λ/2 retardation plate, is arranged upstream of the further optical element. By means of the polarization-influencing optical element, which produces a retardation of λ/4, for example, the two partial beams that are linearly polarized after emerging from the birefringent polarizer element can be converted into circularly polarized partial beams.

In the event of a rotation of the further birefringent optical element, it should be taken into consideration that, for the case where the optical axes of the two birefringent elements do not lie in a common plane (or the planes spanned by the beam axes are not perpendicular to one another), four partial beams or four output laser beams are formed from the input laser beam in the general case, i.e. cascaded beam splitting takes place. If cascaded beam splitting is not desired, it is necessary for the two partial beams entering the further birefringent optical element to be aligned perpendicularly or respectively parallel to the optical axis of the further birefringent optical element. This can be ensured for example by means of a λ/2 retardation plate which is suitably aligned with the two birefringent optical elements and which, during the rotation of the further birefringent optical element, is concomitantly rotated correspondingly (but with half the rotation angle) in order to prevent splitting into four partial beams.

However, the polarization-influencing optical element, e.g. in the form of a λ/4 retardation plate, can also be used to produce four partial beams from the two partial beams. In this case, the polarization-influencing optical element can be used to distribute the power of the input laser beam uniformly among all four partial beams. For the case where the birefringent polarizer element and the further birefringent optical element are rotated relative to one another, it is not necessary to concomitantly rotate the polarization-influencing optical element in the form of the λ/4 retardation plate in order to maintain the effect of uniform splitting. The four partial beams can be superimposed collinearly again depending on the angle of the two birefringent optical elements relative to the optical axis of the processing optical unit or depending on the alignment of the optical axes of the birefringent optical elements relative to the optical axis of the processing optical unit. This can be advantageous if, for example, four or more partial beams are intended to be arranged on a common line or along a preferred direction. Moreover, the distance between the partial beams or the focus zones (see below) can be set by means of a suitable choice of the relative rotation angle of the two birefringent optical elements with respect to one another.

The arrangement comprising the further birefringent optical element and, arranged upstream of the further birefringent optical element, the polarization-influencing optical element, in particular in the form of a λ/4 retardation plate, can be cascaded, i.e. this arrangement can be repeated N times in order to generate a number M of M = 2^{N+1} partial beams from one input laser beam. If all the partial beams are intended to be arranged collinearly and to pass along a common preferred direction, it is typically necessary to arrange the optical axes of all further birefringent optical elements in a common plane. If circularly polarized partial beams are produced with the aid of a respective λ/4 retardation plate, uniform power splitting among all the partial beams can be effected in this case.

It goes without saying that, instead of a λ/4 retardation plate, some other polarization-influencing optical element can also be introduced into the beam path of the partial beams between in each case two successive birefringent optical elements in order to suitably set the polarization and influence the power splitting in this way. Moreover, in order to change the power splitting or in order to switch the splitting on or off, the polarization-influencing optical element can be rotated relative to the respective birefringent optical elements.

In a further embodiment, the processing optical unit comprises a beam shaping optical unit for converting an input laser beam having a Gaussian beam profile into an emerging laser beam having a quasi-nondiffractive beam profile, in particular having a Bessel-like beam profile.

A nondiffractive beam constitutes a solution to the Helmholtz equation which can be separated into a longitudinal portion and into a transverse portion. Such a nondiffractive beam has a transverse beam profile which is propagation-invariant, i.e. which does not change during the propagation of the nondiffractive beam. Depending on the coordinate system used, different solution classes of nondiffractive beams arise, for example Mathieu beams in elliptical-cylindrical coordinates or Bessel beams in circular-cylindrical coordinates.

A nondiffractive beam constitutes a theoretical construct which can be realized to a good approximation in the form of so-called quasi-nondiffractive beams. A quasi-nondiffractive beam has the propagation invariance only over a finite length (characteristic length) L. A quasi-nondiffractive beam is present precisely when, given a similar or identical focus diameter, the characteristic length L significantly surpasses the Rayleigh length of the associated Gaussian focus, in particular if it holds true that: L > Z_{R}, where Z_{R} denotes the Rayleigh length of the Gaussian beam. The characteristic length L can be e.g. of the order of magnitude of 1 mm or more.

One subset of the quasi-nondiffractive beams is constituted by the Bessel-like beams, in which the transverse beam profile in proximity to the optical axis corresponds to a good approximation to a Bessel function of the first kind of order n. One subset of the Bessel-like beams is constituted by the Bessel-Gaussian beams, in which the transverse beam profile in proximity to the optical axis corresponds to a good approximation to a Bessel function of the first kind of order 0 which is enveloped by a Gaussian distribution.

The use of a quasi-nondiffractive beam profile has proved to be advantageous in particular when introducing modifications into the material of the workpiece for glass separating applications or for selective laser etching applications since, in the case of such a beam profile, a substantially homogeneous beam profile can be maintained over a comparatively long distance in a longitudinal direction, whereby a modification volume with a preferred direction is produced.

In this case, a Bessel-like beam has proved to be particularly advantageous, but optionally other quasi-nondiffractive beam profiles, e.g. an Airy beam profile, a Weber beam profile or a Mathieu beam profile, can also be produced by means of the beam shaping optical unit. The beam shaping optical unit can be configured in particular to produce a quasi-nondiffractive beam profile with a beam cross section that is rotationally symmetrical with respect to the propagation direction, as is the case for a Bessel-Gaussian beam, for example.

In one development, the beam shaping optical unit is configured to produce a quasi-nondiffractive beam profile having a non-rotationally symmetrical beam cross section, in particular having a preferred direction. It has proved to be expedient if the beam shaping optical unit is configured as a diffractive optical unit in this case. The preferred direction of the nondiffractive beam profile generally corresponds to the (preferred) direction or the plane in which the polarizer element of the polarizer arrangement produces the two partial beams. The quasi-nondiffractive beam profile can have a plurality of (secondary) maxima spaced apart from one another along the preferred direction, such that the beam shaping optical unit acts in the manner of a beam splitter optical unit and produces a so-called multi-Bessel beam profile, for example. A beam profile having a preferred direction can also be produced with the aid of the cascading - described further above - of birefringent optical elements of the polarizer arrangement with interposed polarization-influencing optical elements.

In one development, the processing optical unit is configured for focusing the partial beams into at least partly overlapping focus zones of a continuous interaction region, in particular along the preferred direction, wherein preferably partial beams each having different polarization states are focused into adjacent focus zones of the continuous interaction region.

If a laser beam which e.g. is generated by a single-mode laser and has a Gaussian beam profile is split into two or more partial beams and the partial beams are at least partially superimposed, this can result in undesired interference effects if the partial beams have the same or a similar polarization. It is true that, during the focusing of the partial beams, the focus zones or the focus cross sections can therefore be arbitrarily close together; in this case, however, the undesired interference effects arise in the resulting intensity profile. Therefore, the partial beams are generally focused in focus zones spaced apart from one another on the workpiece.

With the use of partial beams each having one of two different polarization states, in particular in the form of mutually perpendicular polarization states, the (partial) superimposition in the intensity profile does not give rise to interference effects of the laser radiation from different position or angle ranges, provided that the polarization state of the respective partial beams is uniform over the entire relevant beam cross section or the respective focus zone. The polarization of a respective partial beam should therefore vary as little as possible over the beam cross section or over the focus zone in a position-dependent manner. In this case, the focus zones can be arbitrarily close to one another, partly or possibly completely overlap and even form homogeneous focus zones, specifically both transversely, i.e. perpendicularly to the direction of propagation of the partial beams, and longitudinally, i.e. in the direction of propagation of the partial beams.

Along the predefined, not necessarily rectilinear interaction region a - in the case of a preferred direction linear - beam shape or intensity distribution is formed which generally has a continuous transition, i.e. no zeros in the intensity distribution between the partial beams or between the focus zones. Here partial beams polarized perpendicularly to one another in each case in the respective pairs overlap one another, but only to an extent such that these do not overlap the respectively differently polarized partial beam of a respective pair, such that no superimposition of identically polarized partial beams occurs.

As an alternative to the use of wholly or partly overlapping partial beams having mutually perpendicular polarization states, it is also possible to use wholly or partly overlapping partial beams which have a time offset having a magnitude such that practically no interference effects occur. This is typically the case if the time offset corresponds at least to the order of magnitude of the pulse duration or the order of magnitude of the coherence length. As a minimum here generally 50% of the respective smaller value of the two values (pulse duration and respectively coherence length) is chosen as time offset.

For the focusing of the partial beams or of a plurality of partial beams, each having -in particular in pairs - one of two different polarization states, onto partly overlapping focus zones, use can be made of, in particular, the beam shaping optical unit described further above or the cascading described further above. In this case, the gaps between the maxima of the quasi-nondiffractive beam profile can be filled by splitting the input laser beam into the respective two partial beams at the polarizer element. In this way, it is possible to produce two or more at least partly overlapping focus zones along a predefined contour, generally along the preferred direction.

The beam shaping optical unit can comprise an axicon and/or a diffractive optical element. The production of a (quasi-)nondiffractive beam profile, for example in the form of a Bessel beam, can advantageously be produced by means of an axicon, which typically comprises at least one substantially conical surface. If such an axicon having a rotationally symmetrical conical surface is irradiated with a collimated Gaussian beam, a Bessel-Gaussian beam is typically produced. The axicon can be suitably modified in order to produce a preferred direction of the beam profile (e.g. by using a non-rotationally symmetrical conical surface), in order to produce a homogenization of the beam profile, etc. Alternatively or additionally, a diffractive optical element can be used for producing the (quasi-)nondiffractive beam profile. The properties of an axicon can be simulated and extended by means of such a diffractive optical element. The beam shaping optical unit, optionally alternatively or additionally, can be configured to produce an emerging laser beam having a flat-top beam profile from an entering laser beam having a Gaussian beam profile, etc.

For the case where the partial beams have a quasi-nondiffractive beam profile, e.g. a Bessel-like beam profile, these are focused onto a comparatively long focus volume (e.g. of the order of magnitude of millimeters) in comparison with the diameter of the focus zone (e.g. of the order of magnitude of micrometers) during the focusing by means of the focusing optical unit. Nevertheless, even in the context of beam profiles of this type, the text below refers to focusing into a focal plane, for simplification. The focal plane and respectively the planes described further below are predefined by the properties of the respective optical units (independently of the type of beam profile).

Besides being dependent on the type of laser processing, the arrangement of the polarizer arrangement or of the birefringent polarizer element in the beam path of the processing optical unit is dependent on whether a pure position offset, a pure angle offset or a combination of a position offset and an angle offset is intended to be produced.

The birefringent polarizer element of the polarizer arrangement can be configured for producing an angle offset and can be arranged in a plane that is optically conjugate with respect to the focal plane. A plane that is optically conjugate with respect to the focal plane is understood to mean a plane that is correlated with the focal plane by way of a Fourier transformation, i.e. an angle-to-position transformation. If it is assumed that the focusing optical unit has an (effective) image-side focal length f₂, the conjugate plane with the polarizer element configured for producing an angle offset is typically arranged at the distance of the object-side focal length f₁ of the focusing optical unit. For the special case where f₁ = f₂ = f holds true, the birefringent polarizer element is arranged at the distance 2 f (or generally 2 f + N × 4 f, where N is greater than or equal to 0, and N is an integer) from the focal plane. Hereinafter, for simplification, reference is made to a 2f set-up even if the condition f₁ = f₂ = f is not met.

Alternatively, the birefringent polarizer element of the polarizer arrangement can be configured for producing a position offset and can be arranged upstream of a further, preferably collimating optical unit in the beam path, wherein the processing optical unit is configured to image the position offset between the partial beams polarized perpendicularly to one another at the polarizer element into the focal plane. In this case, the birefringent polarizer element can be arranged in a plane corresponding to the focal plane upstream of the further optical unit. Such a plane is correlated with the focal plane by way of two angle-to-position transformations, for example. If it is assumed that the focusing optical unit has an (effective) focal length of f, the plane corresponding to the focal plane with the birefringent polarizer element, in a special case where identical focal lengths are used for the collimation and the focusing, can be arranged at a distance of 4 f (or generally of 4 f + N × 4 f, where N is greater than or equal to zero, and N is an integer) from the focal plane. Hereinafter, for simplification, reference is made to a 4f set-up even if the optical elements used do not necessarily have a uniform focal length f. For the case where the birefringent polarizer element is arranged in the (substantially) collimated beam path, the exact arrangement of the polarizer element at a predefined distance from the focal plane is generally not important; all that is essential is an (extensive) position-to-position transformation, i.e. a mapping between the plane with the polarizer element and the focal plane.

However, the birefringent polarizer element should be arranged in the beam path upstream of the further optical unit, which can be configured for example as a collimating optical unit for producing an angle-to-position transformation. Together with the angle-to-position transformation (or equivalently position-to-angle transformation) produced by the focusing optical unit, the position offset of the partial beams that is produced at the polarizer element is converted or mapped into a position offset in the focal plane. The further, e.g. collimating optical unit, jointly with the focusing optical unit, can bring about an imaging of the plane with the birefringent polarizer element onto the focal plane, i.e. onto a plane linked with the focus zone, with a predefined, e.g. reducing, imaging scale.

The polarizer arrangement is generally arranged significantly upstream of the back focal plane of the focusing optical unit in the beam path of the processing optical unit. This affords two important advantages: Firstly, the fluences in the back focal plane are very high since a ring focus forms there in the quasi-Bessel case. In combination with short pulses at high pulse energy, optical units near this plane can be damaged by the laser radiation. In addition, the back focal plane does not have good mechanical accessibility, particularly in the case of short focal lengths of the focusing optical unit.

In the case of the processing optical unit described here, spatial separation of the beam paths of the partial beams produced by the polarizer arrangement is typically not necessary. With the aim of a compact and robust realization of the processing optical unit, the partial beams typically at least partly overlap substantially over the entire optical path length traversed as far as the workpiece to be processed. Furthermore, in general, all partial beams produced by the polarizer arrangement pass through the same optical components.

The processing optical unit can have a preferably diffractive beam splitter optical unit for producing a plurality of pairs of partial beams polarized perpendicularly to one another. The beam splitter optical unit can be configured in the form of a diffractive optical element, for example, but some other type of beam splitter optical unit can also be involved, for example a geometric beam splitter optical unit. The beam splitter optical unit can be arranged upstream of the polarizer element or upstream of the polarizer arrangement in the beam path of the laser beam entering the processing optical unit and can produce a plurality of input laser beams which are split in each case into a pair of partial beams polarized perpendicularly to one another at the polarizer element. The opposite case is possible, too, i.e. the beam splitter optical unit can be arranged downstream of the birefringent polarizer element in the beam path. In this case, from the pair of partial beams generated by the polarizer element, the beam splitter optical unit produces a plurality of pairs of partial beams, the focus zones of which can partly overlap one another along a preferred direction in particular as described further above.

The beam splitter optical unit can be arranged in a plane that is optically conjugate with respect to the focal plane. An angle offset between the pairs of partial beams can be produced in the plane that is conjugate with respect to the focal plane, said angle offset being transformed into a position offset in the focal plane by the focusing optical unit. In this case, the beam splitter optical unit can be arranged for example in a plane that is optically conjugate with respect to the focal plane between the further imaging optical unit described further above and the focusing optical unit, in order to produce the plurality of pairs of partial beams from a pair of partial beams produced by the polarizer element.

The preferably diffractive beam splitter optical unit can also be configured as a beam shaping optical unit for converting an entering laser beam having a Gaussian beam profile into an emerging laser beam having a flat-top beam profile. The shaping of a laser beam having a flat-top beam profile, i.e. having a beam profile which has a substantially homogeneous intensity distribution with steeply falling edges, makes it possible to control the intensity distribution on a surface oriented substantially perpendicularly to the propagation direction. For details concerning the shaping of the flat-top beam profile, reference should be made to DE 10 2019 205 394.7, cited in the introduction, the content of which is incorporated by reference in its entirety in the content of this application.

In a further embodiment, the processing optical unit comprises a rotary drive for rotating the polarizer arrangement and/or the beam shaping optical unit about an (optionally common) rotation axis. The rotation axis of the rotary drive typically corresponds to the optical axis of the processing optical unit. The rotation is expedient in particular if the intention is to produce partly overlapping focus zones along a predefined interaction region, in particular along a preferred direction.

During rotation, what has an expedient effect is the fact that the birefringent polarizer element or the polarizer arrangement overall contains only alignment-noncritical components, which fosters use in adaptive optics, in particular. However, the position offset or the angle offset produced by the polarizer element is generally not symmetrical with respect to the direction of propagation of the input beam, i.e. with respect to the optical axis or with respect to the rotation axis. During the rotation of the polarizer element about a rotation axis, which generally runs in a longitudinal direction, i.e. along the direction of propagation of the input beam or the optical axis of the processing optical unit, possibly an undesired, rotation-angle-dependent angle offset and/or position offset of the partial beams therefore occurs. In order to compensate for said offset, it is possible to use a suitably configured further optical element, for example the wedge-shaped optical element described further above, in the polarizer arrangement.

During workpiece processing in the form of a laser cutting process for cutting glass along a processing path, it may be necessary or expedient to vary the preferred direction of the focus zones depending on a position-dependently variable advance direction during the movement relative to the workpiece, in order to promote crack propagation in the glass along the advance direction. The targeted orientation of cracks during glass separation makes it possible to work in a process regime that enables significantly simplified separation of the glass. In such a glass cutting application, generally the focus zones of two or more quasi-nondiffractive beams with a comparatively long focus volume, for example in the form of Bessel-like beams, in particular in the form of Bessel-Gaussian beams, are at least partly superimposed spatially, as has been described in greater detail further above. For varying the preferred direction, in this case it is not necessary for alignment-critical optical elements such as e.g. lens elements likewise to be rotated, even if such a rotation is likewise possible in principle.

The invention also relates to a laser processing apparatus, comprising: a processing optical unit configured as described further above, and also a laser source, in particular an ultrashort pulse laser source, for generating a laser beam, in particular a laser beam having a Gaussian beam profile. The laser source is preferably configured for generating a single-mode laser beam having a Gaussian beam profile, but this is not absolutely necessary. The processing optical unit can be accommodated for example in a laser processing head or in a housing of a laser processing head, in particular in the form of a module or in the form of modules of a modularly constructed laser processing head, which is movable relative to the workpiece. Alternatively or additionally, the laser processing apparatus can comprise a scanner device in order to align the partial beams with the workpiece or with different positions on the workpiece. Besides the optical units described further above, the processing optical unit can also comprise further optical units enabling, for example, spatial filtering or spatial rearrangement of the input laser beam in order to foster the beam shaping, e.g. the homogenization of a Bessel-like beam profile, mask imaging, etc.

For glass separating applications or for other applications, the laser source can be configured to generate a laser beam having single pulses or having burst pulses (e.g. 2-6 pulses in the burst with a burst pulse separation of 2 ns to 150 ns, preferably 13 ns to 40 ns). The single pulses or the pulses in the burst advantageously have a pulse duration of between 200 fs and 20 ps, in particular between 300 fs and 20 ps. The pulse energy (total burst or in the single pulse) is preferably between 10 µJ and 10 mJ, in particular between 30 µJ and 1 mJ. In the case of a glass separating application, the spatial pulse distance or the modification distance between adjacent focus zones of the interaction region which is produced by the laser processing apparatus is preferably between approximately 0.8 µm and approximately 30 µm.

The invention also relates to a method of the type mentioned in the introduction, further comprising: changing an angle and/or a distance of at least one of the partial beams relative to an optical axis of the processing optical unit at at least one further optical element of the polarizer arrangement arranged downstream of the birefringent polarizer element in the beam path. The method affords the advantages described further above in association with the processing optical unit. The laser processing or the workpiece processing can be laser ablation, laser cutting, surface structuring, laser welding, laser drilling, ...

Further advantages of the invention are evident from the description and the drawing. Likewise, the features mentioned above and those that will also be presented further can be used in each case by themselves or as a plurality in any desired combinations. The embodiments shown and described should not be understood as an exhaustive enumeration, but rather are of exemplary character for outlining the invention.

In the following description of the drawings, identical reference signs are used for identical or functionally identical components.

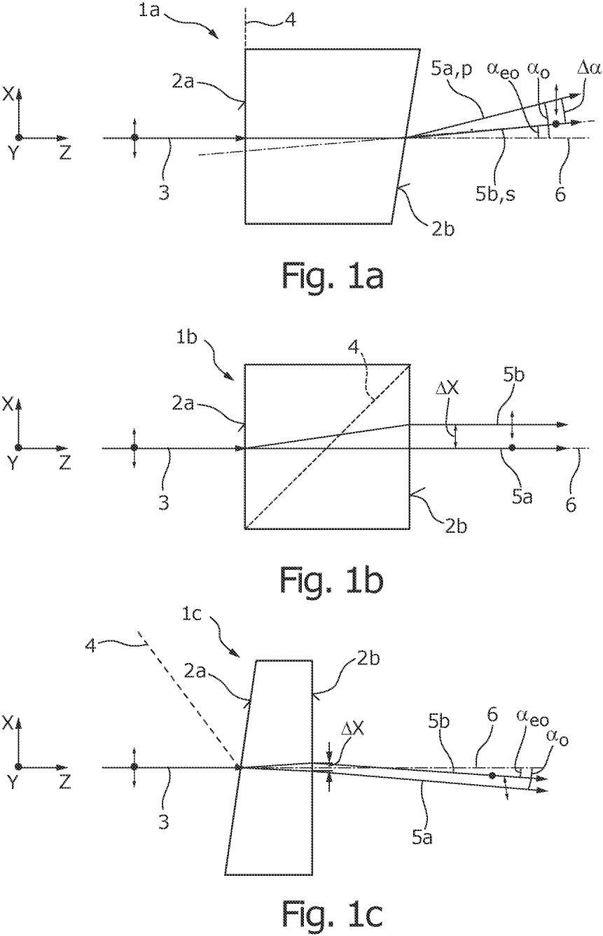

FIGS. 1a-c each show schematically a birefringent polarizer element 1a, 1b, 1c in the form of a birefringent crystal. Various birefringent materials can be used as crystal material for the polarizer element 1a, 1b, 1c, e.g. alpha-BBO (alpha-barium borate), YVO4 (yttrium vanadate), crystalline quartz, etc.

The birefringent polarizer element 1a from FIG. 1a is configured in a wedge-shaped fashion, i.e. a planar beam entrance surface 2a for the entrance of an input laser beam 3 and a planar beam exit surface 2b of the polarizer element 1a are oriented at a (wedge) angle with respect to one another. The optical axis or an optical axis 4 of the crystal material is oriented parallel to the beam entrance surface 2a.

The unpolarized, elliptically polarized or circularly polarized input laser beam 3 entering the birefringent polarizer element 1a shown in FIG. 1a perpendicularly to the beam entrance surface 2a is split into two partial beams 5a, 5b, which are perpendicular to one another (s- and p-polarized, respectively), at the beam exit surface 2b, which is inclined at an angle with respect to the beam entrance surface 2a. In FIG. 1a, as generally customary, the first, p-polarized partial beam 5a is identified by a double-headed arrow, while the second, p-polarized partial beam 5b is identified by a dot. The first, p-polarized partial beam 5a is refracted to a greater extent than the second, s-polarized partial beam 5b upon emergence from the birefringent polarizer element 1a, with the result that an angle offset Δα occurs between the first and second partial beams 5a, 5b. In this case, the first and second partial beams 5a, 5b emerge from the birefringent polarizer element 1a at the same location at the beam exit surface 2b, that is to say that the angle offset Δα, but no position offset, is produced between the two partial beams 5a, 5b by the birefringent polarizer element 1a.

As can likewise be discerned in FIG. 1a, the first partial beam 5a, which forms the ordinary ray, is refracted at a first angle αₒ relative to an optical axis 6 forming the extension of the direction of propagation of the entrance laser beam 3 (not to be confused with the optical axis 4 of the birefringent crystal). The second partial beam 5b, which forms the extraordinary ray, is refracted at a second, smaller angle αₑₒ relative to the optical axis 6.

The power proportions when the entrance laser beam 3 is split into the first partial beam 5a in the form of the ordinary ray and the second partial beam 5b in the form of the extraordinary ray are dependent on the polarization of the entrance laser beam 3: If the entrance laser beam 3 is elliptically polarized, the power ratio of the partial beam 5a in the form of the ordinary ray and the partial beam 5b in the form of the extraordinary ray can be set by the ratio of the semi-axes of the entrance laser beam 3 in the X-direction and in the Y-direction, respectively. In the case of an unpolarized, linearly polarized or circularly polarized entrance laser beam 3, the power proportions can optionally be set by a different alignment relative to the XZ-plane. The use of an unpolarized or circularly polarized input laser beam 3 is advantageous in particular if the preferred direction is intended to be rotated during processing (see below).

In the case of the polarizer element 1b shown in FIG. 1b, the beam entrance surface 2a and the beam exit surface 2b are aligned parallel to one another and the optical axis 4 of the birefringent crystal material is oriented at an angle of 45° with respect to the beam entrance surface 2a. In this case, the input beam 3 impinging perpendicularly to the beam entrance surface 2a is split into a first partial beam 5a in the form of an ordinary ray and a second partial beam 5b in the form of an extraordinary ray at the beam entrance surface 2a. The two partial beams 5a, 5b emerge parallel, i.e. without an angle offset, but with a position offset Δx at the beam exit surface 2b.

In the case of the polarizer element 1c shown in FIG. 1c, the beam entrance surface 2a is oriented at an angle with respect to the optical axis 6 and the beam exit surface 2b is oriented perpendicularly to the optical axis 6. In the example shown, the optical axis 4 of the crystal material is oriented at an angle of 45° with respect to the beam exit surface 2b, but can also be oriented at a different angle. In this case, the input beam 3 impinging perpendicularly to the beam exit surface 2b is split into a first partial beam 5a in the form of an ordinary ray and a second partial beam 5b in the form of an extraordinary ray at the beam entrance surface 2a. The two partial beams 5a, 5b emerge with an angle offset Δα and with a position offset Δx at the beam exit surface 2b.

The birefringent polarizer elements 1a, 1b, 1c illustrated in FIG. 1a to FIG. 1c thus differ fundamentally in that the polarizer element 1a shown in FIG. 1a produces an angle offset Δα (without a position offset), the polarizer element 1b shown in FIG. 1b produces a position offset Δx (without an angle offset) and the polarizer element 1c illustrated in FIG. 1c produces a position offset Δx and an angle offset Δα.

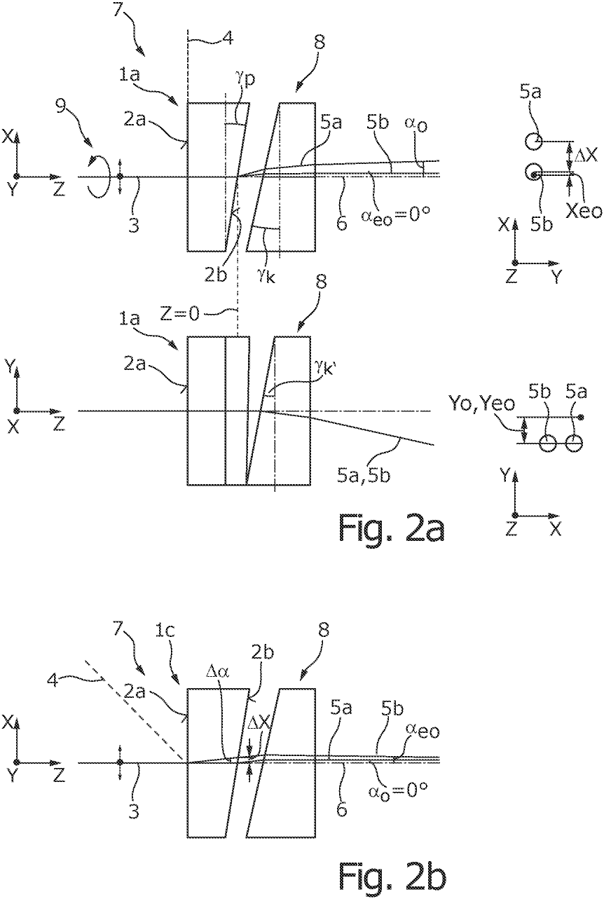

The polarizer elements 1a-c shown in FIGS. 1a-c can each form a component of a polarizer arrangement 7 such as is illustrated in FIGS. 2a,b, for example. The polarizer arrangement 7 in FIGS. 2a,b has in each case an additional optical element 8, which is a non-birefringent, optically isotropic optical element. In the case of the polarizer arrangement 7 shown in FIG. 2a, the polarizer element 1a is configured as illustrated in FIG. 1a and serves for producing an angle offset Δα without producing a position offset. As can be discerned in FIG. 2a and in particular in FIG. 1a, the two partial beams 5a,b are refracted to different extents in the same direction by the birefringent optical element 1a, i.e. neither of the two partial beams 5a, 5b passes parallel to the optical axis 6 upon emerging from the birefringent polarizer element 1a.

This proves to be disadvantageous if the entire polarizer arrangement 7 is rotated about the optical axis 6 by means of a rotary drive 9, as is illustrated in FIG. 2a, since this can result in unwanted beam wobble of the two partial beams 5a, 5b about the optical axis 6. In order to avoid this, in the case of the polarizer arrangement 7 illustrated in FIG. 2a, the further, wedge-shaped optical element 8, the optically isotropic material of which can be synthetic quartz glass (“fused silica”), for example, is coordinated with the polarizer element 1a such that one of the two partial beams 5a,b, the second partial beam 5b in the form of the extraordinary ray in the example shown, is aligned parallel to the optical axis 6.

In order to achieve this, a wedge angle γK of the wedge-shaped optically isotropic element 8 - taking account of the respective refractive indices of the materials used - is adapted to the wedge angle γp of the beam exit surface 2b of the birefringent polarizer element 1a, such that the second partial beam 5b, upon entering the optically isotropic element 8, is refracted in such a way that it is aligned parallel to the optical axis 6, i.e. αₑₒ = 0°. Owing to the small distance between the birefringent polarizer element 1a and the optically isotropic element 8, the second partial beam 5b passes almost exactly along the optical axis 6, i.e. said partial beam has only a very small distance from the optical axis 6; also cf. the illustration in FIG. 2a on the right-hand side, which shows a plan view of the two partial beams 5a,b in the XY-plane perpendicular to the optical axis 6. The angle offset Δα between the two partial beams 5a,b is maintained during passage through the optically isotropic element 8. It is possible for the second partial beam 5b to be positioned exactly on the optical axis 6 if the optically isotropic element 8 is rotated or tilted about the Y-axis. In a manner similar to the case of a tilted plane-parallel optical element, in this case an additional parallel offset of the two partial beams 5a, 5b arises, which can be chosen such that the first partial beam 5a passes along the optical axis 6.

Generally, the rotation axis Z (of an XYZ-coordinate system) coinciding with the optical axis 6 is fixedly predefined and, through the choice of the wedge angle γK - shown in FIG. 2a - of the wedge-shaped optically isotropic element 8, which lies in the XZ-plane, and also through the choice of the wedge angle γp of the birefringent polarizer element 1a, the two partial beams 5a, 5b can be positioned at arbitrary distances in the X-direction with respect to the rotation axis Z. The distance Xₑₒ between the second partial beam 5b in the form of the extraordinary ray and the optical axis 6 is dependent on the wedge angle γK of the wedge-shaped optically isotropic element 8 and, in the example shown, is not dependent on the position in the Z-direction since the second partial beam 5b is aligned parallel to the optical axis 6. The position offset ΔX between the two partial beams 5a, 5b is dependent on the wedge angle γp of the birefringent polarizer element 1a and also on the position in the Z-direction.

In addition to the positioning of the two partial beams 5a, 5b in the X-direction, in the case of the example shown in FIG. 2a, in which the optically isotropic element 8 has an additional wedge angle γK’ in the ZY-plane (cf. bottom of FIG. 2a), the two partial beams 5a, 5b can also be deflected jointly in the YZ-plane. As can be discerned at the bottom right in FIG. 2a, in this way it is possible to predefine the (identical) distance Yₒ, Yₑₒ between the two partial beams 5a, 5b and the optical axis 6 in the Y-direction, which distance is dependent on the position in the Z-direction.

The polarizer arrangement 7 shown in FIG. 2a, which uses a birefringent polarizer element 1a which produces only an angle offset Δα, but not a position offset, can be realized in a compact design and has proved to be particularly advantageous in applications in which a rotation of the polarizer arrangement 7 about the rotation axis Z is required. By way of example, the polarizer arrangement 7 can be integrated into a mechanical mount in a particularly simple manner. Moreover, the use of the polarizer element 1a has proved to be advantageous compared with the use of the polarizer element 1b shown in FIG. 1b in such applications for other reasons.

FIG. 2b shows a polarizer arrangement 7 having a birefringent polarizer element 1c which, as in FIG. 1c, produces both a position offset Δx and an angle offset Δα. In the case of the polarizer element 1c shown in FIG. 2b, the optical axis 4 of the birefringent crystal is oriented at 45° with respect to the beam entrance surface 2a. The position offset Δx at the beam exit surface 2b is dependent on the orientation of the optical axis 4 of the birefringent crystal and is maximal in the case of the orientation at 45° as shown. In the case, too, of the polarizer arrangement 7 illustrated in FIG. 2b, one of the two partial beams 5a,b is aligned parallel to the optical axis 6 at the optically isotropic wedge-shaped element 8. In contrast to the example shown in FIG. 2a, however, the partial beam involved here is the first partial beam 5a in the form of the ordinary ray. As can likewise be discerned in FIG. 2b, both partial beams 5a, 5b are refracted toward the optical axis 6 at the optically isotropic element 8. The first partial beam 5a in the form of the ordinary ray passes parallel to the optical axis 6 downstream of the optically isotropic element 8, while the second partial beam 5b in the form of the extraordinary ray, after passing through the optically isotropic element 8, passes toward the optical axis 6 and intersects the latter at an angle αₑₒ.

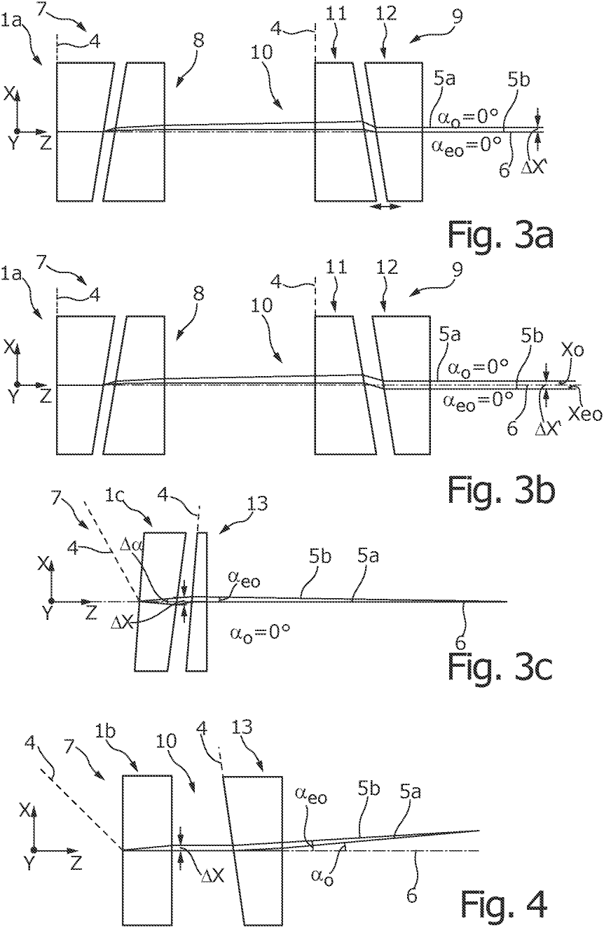

FIGS. 3a,b each show a polarizer arrangement 7 configured to align the two partial beams 5a,b parallel to one another. For this purpose, the polarizer arrangement 7 shown in FIGS. 3a,b has the arrangement - shown in FIG. 2a - comprising the birefringent polarizer element 1a and the optically isotropic element 8 and also a beam offset optical unit 9 disposed downstream in the beam path 10, said beam offset optical unit having a further birefringent optical element 11 and also a further optically isotropic element 12 disposed downstream in the beam path 10. The further birefringent optical element 11 of the beam offset optical unit 9 serves to align the two partial beams 5a, 5b parallel to one another upon emerging from the further birefringent optical element 11. The two partial beams 5a,b aligned parallel to one another are refracted at a beam entrance surface of the further optically isotropic element 12 and in the process are aligned parallel to the optical axis 6, such that both partial beams 5a, 5b are at an angle αₒ and αₑₒ, respectively, of 0° with respect to the optical axis 6.

In the case of the example shown in FIG. 3a, the distance between the further birefringent optical element 11 and the further optically isotropic element 12 along the optical axis 6 is chosen such that the second partial beam 5b is positioned exactly on the optical axis 6. With the aid of the polarizer arrangement 7 shown in FIG. 3a, moreover, both partial beams 5a,b can be aligned parallel to one another such that, upon emerging from the polarizer arrangement 7, they have a beam offset Δx’ but no angle offset with respect to one another, without a birefringent polarizer element 1b which produces a position offset Δx without an angle offset Δα having to be used for this purpose.

By varying the distance along the optical axis 6 (in the Z-direction) between the optically isotropic element 8 and the beam offset optical unit 11, it is possible to set the beam offset Δx’ upon emergence from the polarizer arrangement 7. If the distance in the Z-direction between the further birefringent optical element 11 and the further optically isotropic element 12 of the beam offset optical unit 11 is additionally adapted in a suitable manner, the second partial beam 5b can always be positioned on the optical axis 6.

As an alternative to the positioning of the second partial beam 5b on the optical axis 6, as illustrated in FIG. 3a, both partial beams 5a, 5b can be positioned at the same distance Xₒ, Xₑₒ from the optical axis 6, as illustrated in FIG. 3b. For this purpose, it is necessary to suitably choose or adapt the distance in the Z-direction between the further birefringent optical element 11 and the further optically isotropic element 12. In this case, too, the beam offset Δx’ of the two partial beams 5a, 5b upon emerging from the polarizer arrangement 7 and thus their distance from the optical axis 6, as has been described further above, can be set by varying the distance between the optically isotropic element 8 and the beam offset optical unit 11 along the optical axis 6 (i.e. in the Z-direction).

FIG. 3c shows a polarizer arrangement 7 having a birefringent polarizer element 1c configured for producing a position offset Δx in addition to producing an angle offset Δα. The polarizer arrangement 7 comprises a further optical element 13 configured in a birefringent fashion in order to align the first partial beam 5a parallel to the optical axis 6 (aₒ = 0°) and to position it on the optical axis 6. At the further birefringent optical element 13, the second partial beam 5b in the form of the extraordinary ray is refracted toward the optical axis 6 and forms an angle αₑₒ therewith.

The polarizer arrangement 7 shown in FIG. 4 has a birefringent polarizer element 1b which is configured as in FIG. 1b and which produces a position offset Δx without an angle offset Δα. A further birefringent optical element 13 is arranged downstream of the birefringent polarizer element 1b in the beam path 10, the two partial beams 5a,b oriented at an angle αₒ and αₑₒ, respectively, of 0° with respect to the optical axis 6 being refracted to different extents by said optical element, such that they are each at an angle αₒ and αₑₒ, respectively, with respect to the optical axis 6 after passing through the further birefringent optical element 13. The angle αₑₒ at which the second partial beam 5b in the form of the extraordinary ray passes with respect to the optical axis 6 is smaller here than the angle αₒ at which the first partial beam 5a passes with respect to the optical axis 6. Owing to the position offset Δx between the two partial beams 5a, 5b, they intersect at a predefined distance downstream of the polarizer arrangement 7, as can likewise be discerned in FIG. 4. The polarizer arrangement 7 shown in FIG. 4 has properties similar to those of the polarizer arrangement 7 shown in FIG. 3c. In the case of the polarizer arrangement 7 shown in FIG. 4, however, the distance between the birefringent polarizer element 1b and the further birefringent optical element 13 in the Z-direction can be chosen freely, with the result that this polarizer arrangement 7 is less tolerance-sensitive.

In contrast to what is illustrated in FIG. 3c and in FIG. 4, the average angle ½(αₒ + αₑₒ) at which the two partial beams 5a, 5b are oriented with respect to the optical axis 6 can also be 0° (αₒ = - αₑₒ). In this case, the two partial beams 5a, 5b pass mirror-symmetrically with respect to the ZY-plane.

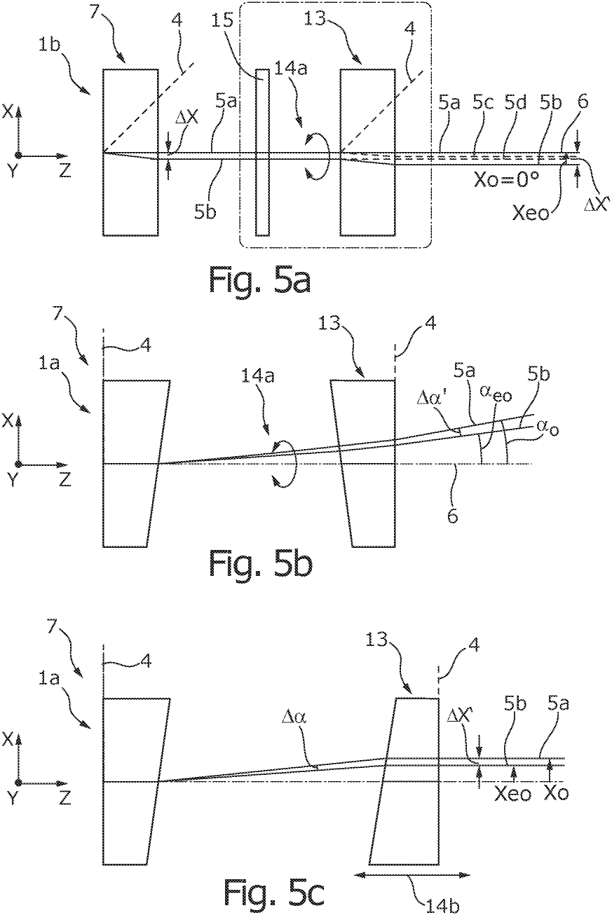

FIGS. 5a-c each show a polarizer arrangement 7 configured to change the constant angle offset Δα and/or constant position offset Δx predefined by a respective birefringent polarizer element 1α, 1b. For this purpose, the polarizer arrangement 7 in FIGS. 5a-c in each case has a further birefringent optical element 13.

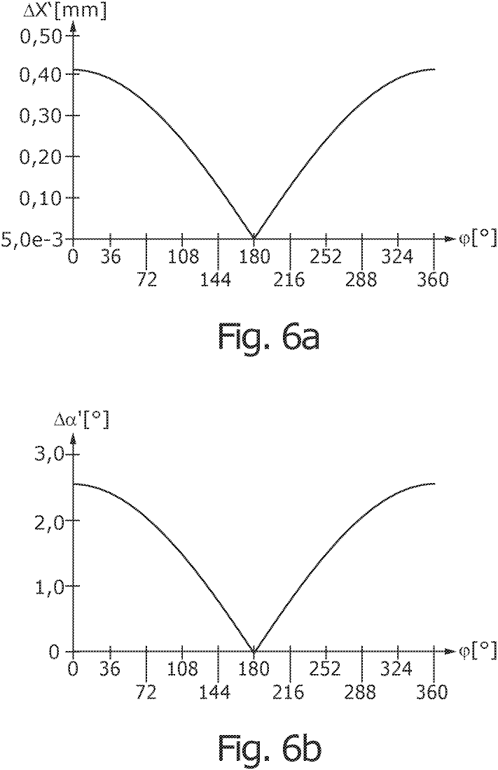

In the case of the polarizer arrangement 7 shown in FIG. 5a, the birefringent polarizer element 1b is configured for producing a constant position offset Δx (without an angle offset) between the two partial beams 5a, 5b and the further birefringent optical element 13 is also configured for producing a position offset (without an angle offset). The polarizer arrangement has a rotary drive 14a configured for rotating the further optical element 13 about a rotation axis Z corresponding to the optical axis 6. By rotating the further birefringent optical element 13 about the rotation axis Z at a respective adjustable rotation angle φ, it is possible to set a position offset Δx’ - produced by the polarizer arrangement 7 - between the two partial beams 5a, 5b, as can be discerned in FIG. 6a.

In the case of the example shown in FIG. 5a, a polarization-influencing optical element 15 e.g. in the form of a suitably aligned λ/2 retardation plate is arranged upstream of the further birefringent optical element 13. This is advantageous since, for the case where the optical axes 4 of the birefringent polarizer element 1b and of the birefringent further optical element 13 do not lie in one plane, four partial beams 5a-d, rather than two partial beams, are formed in the general case, as is indicated in a dashed manner in FIG. 5a. If, during the rotation of the further birefringent optical element 13, the λ/2 retardation plate 15 is concomitantly rotated correspondingly (with half the rotation angle), what can be achieved is that, during the rotation of the further birefringent optical element 13 as well, the power of the input laser beam is split only between two partial beams 5a, 5b.

For the case where the polarization-influencing optical element 15 is configured as a λ/4 retardation plate, the two partial beams 5a, 5b that are linearly polarized after emerging from the birefringent polarizer element 1b can be converted into circularly polarized partial beams. With the aid of the λ/4 retardation plate 15 or with the aid of other polarization-influencing optical elements, the power of the input laser beam can be split between the two partial beams 5a, 5b in a targeted manner.

It is also possible, with the aid of the λ/4 retardation plate 15, to perform cascaded beam splitting in a targeted manner in order to produce four partial beams 5a-d, for example, as is indicated in FIG. 5a. Given a suitable alignment of the λ/4 retardation plate 15 with respect to the further birefringent optical element 13, the power of the input laser beam can be split uniformly among the four partial beams 5a-d in this case, too. For the case where, in the event of such splitting, the polarization-influencing optical element 13 is rotated with the aid of the rotary drive 14a, in order to set the distance or the beam offset ΔX between the partial beams 5a-d in the X-direction, it is typically not necessary for the λ/4 retardation plate 15 to be concomitantly rotated correspondingly in order to maintain the effect of uniform splitting.

The arrangement comprising the further birefringent optical element 13 and, arranged upstream thereof, the polarization-influencing optical element 15, e.g. in the form of the λ/4 retardation plate, can be cascaded, i.e. the arrangement surrounded by a dashed frame in FIG. 5a can be arranged repeatedly N times in the beam path in order to generate a number M of M = 2^{N+1} partial beams from one input laser beam.

Depending on the rotation angle φ of the two birefringent optical elements 7, 13 relative to one another or depending on the alignment of the optical axes 4 of the birefringent optical elements 7, 13 relative to one another, the four partial beams 5a-d can again be superimposed collinearly, as is indicated in FIG. 5a. If all four or more partial beams 5a-d are intended to be arranged collinearly and to pass along a common preferred direction, e.g. the X-direction, it is typically necessary to arrange the optical axes 4 of all further birefringent optical elements 13 in a common plane in the course of the cascading. If circularly polarized partial beams are produced with the aid of a respective λ/4 retardation plate 15, uniform power splitting among all M= 2^{N+1} partial beams can be effected in the case of such cascading as well.

In the case of the polarizer arrangement 7 shown in FIG. 5b, the further birefringent optical element 13 is likewise rotatable relative to the birefringent polarizer element 1a about the optical axis 6 by means of a rotary drive 14 in order to set or to change an angle offset Δα’ produced by the polarizer arrangement 7. In the case of the polarizer arrangement 7 shown in FIG. 5b, the birefringent polarizer element 1a is configured for producing a constant angle offset Δα and the angle offset Δα‛produced by the polarizer arrangement 7 can be set depending on the rotation angle φ of the further birefringent optical element 13, as is illustrated in FIG. 6b. In order to avoid splitting among four partial beams 5a-d during the rotation, a polarization-influencing optical element 15 can be arranged upstream of the further birefringent optical element 13 in the case of the example illustrated in FIG. 5b as well.

In the case of the polarizer arrangement 7 shown in FIG. 5c, the further birefringent optical element 13 is displaceable along the optical axis 6 with the aid of a translational drive 14b. As in FIG. 5b, the birefringent polarizer element 1a is configured for producing a constant angle offset Δα (without a position offset). With the aid of the further wedge-shaped birefringent optical element 13, the (constant) angle offset Δα is converted into a position offset Δx’,the magnitude of which is dependent on the distance between the birefringent polarizer element 1a and the birefringent further optical element 13, which distance is changed with the aid of the translational drive 15.

In the examples shown in FIGS. 5a-c, in the simplest case, the respective birefringent polarizer element 1a, 1b and the further birefringent optical element 13 can be configured structurally identically.

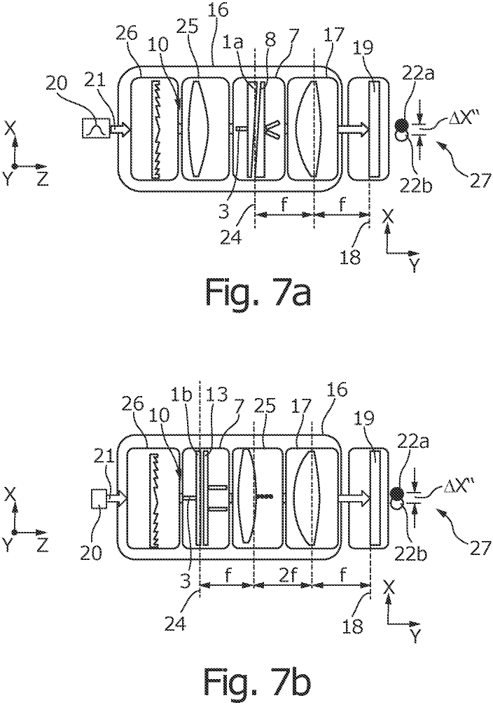

All polarizer arrangements 7 illustrated further above can form a component of a processing optical unit 16, which can be configured for example as illustrated in FIGS. 7a,b. The processing optical unit 16 illustrated in FIGS. 7a,b comprises a focusing optical unit 17, which serves for focusing the two partial beams 5a, 5b in the region of a focal plane 18, which lies at the top side of a workpiece 19 to be processed in FIGS. 2a,b. In contrast to the illustration in FIGS. 7a,b, the focal plane 18 can also lie in the beam path 10 of the processing optical unit 16 just upstream of the workpiece 19, in a plane within the workpiece 19 or just downstream of the workpiece 19. The input laser beam 3 that impinges on the birefringent polarizer element 1a-c of the polarizer arrangement 7 corresponds to a laser beam 21 which is generated by a laser source 20 and enters the processing optical unit 16. The processing optical unit 16 shown in FIGS. 7a,b is configured to focus the two partial beams 5a, 5b onto two focus zones 22a, 22b in or in proximity to the focal plane 18, which partly overlap one another and which are represented by a black circle and a white circle in FIGS. 7a,b. The processing optical unit 16 illustrated in FIG. 7a, together with the laser source 11, forms a laser processing apparatus 23 for processing the workpiece 19, for example in the form of ablating laser processing. For this purpose, the processing optical unit 16 can be moved relative to the workpiece 19 and/or comprise a scanner device for aligning the partial beams 5a, 5b with different positions in the region of the focal plane 18.

In the case of the processing optical unit 6 illustrated in FIG. 7a, the polarizer arrangement 7 having the birefringent polarizer element 1a and the further optically isotropic element 8 from FIG. 2a is arranged in or in proximity to a plane 24 that is optically conjugate with respect to the focal plane 18. The optically conjugate plane 24 is linked with the focal plane 18 by an angle-to-position transformation (Fourier transformation) produced by the focusing optical unit 17. Angles in the optically conjugate plane 24 correspond to positions in the focal plane 18, and vice versa. The two partial beams 5a, 5b emerging from the polarizer element 1a with the angle offset Δα are therefore focused with a position offset ΔX″ of the two centers of the focus zones 22a,b in the focal plane 18 which is smaller than the diameter of the focus zones 22a,b, such that the two focus zones 22a,b overlap one another. Owing to the absence of the position offset of the two partial beams 5a, 5b emerging from the polarizer element 1a, the two partial beams 5a, 5b, after passing through the focusing optical unit 17, are oriented parallel and perpendicularly to the focal plane 18. In the example shown in FIG. 7a, the distance between the focal plane 18 and the optically conjugate plane 24 is 2 f, wherein f denotes the focal length of the focusing optical unit 17.

The processing optical unit 16 illustrated in FIG. 7b comprises a further imaging optical unit 25, which is arranged upstream of the focusing optical unit 17 in the beam path 10. The further imaging optical unit 25, jointly with the focusing optical unit 17, images the two partial beams 5a, 5b into the focal plane 18, said partial beams having been produced with a variable position offset Δx′ at the birefringent polarizer element 1b of the polarizer arrangement 7 from FIG. 5a, said polarizer element being arranged upstream of the further imaging or collimating optical unit 25 in the beam path 10. The imaging scale during the imaging into the focal plane 18 is chosen here in such a way that the diameter of the two partial beams 5a,b and the distance Δx″ between the two partial beams 5a,b in the focal plane 8 are reduced. In the example illustrated in FIG. 7b, for simplification, the polarizer element 1b is arranged at a distance of 4 f from the focal plane 18 in a further plane 24, corresponding to the focal plane 18. In general, the further optical unit 25 and the focusing optical unit 17 have different focal lengths f₁, f₂, i.e. the further plane 24 is arranged at the distance 2 (f₁ + f₂). Through the choice of suitable different focal lengths f₁, f₂, it is possible to set the imaging scale, for example in order to bring about the reduction described further above.

The spatial distribution in the further plane 24 corresponds to the spatial distribution in the focal plane 18 (with an adaptation of the scale). Since the polarizer element 1b is arranged in the collimated beam path 10 of the laser beam 21 that enters the processing optical unit 16, it is not absolutely necessary for said polarizer element to be positioned in the further plane 24; rather, said polarizer element can also be arranged upstream or downstream of the further plane 24 in the beam path 10.

The processing optical unit 16 in FIGS. 7a,b also comprises a beam shaping optical unit 26 for converting a laser beam entering the processing optical unit 16, which laser beam, in the example shown, corresponds to the laser beam 21 having a Gaussian beam profile that is generated by the laser source 20, into an input laser beam 3 having a quasi-nondiffractive beam profile, to put it more precisely having a Bessel-like beam profile, which impinges on the polarizer arrangement 7.

The Bessel-like beam profile can be rotationally symmetrical with respect to the direction of propagation, but it is also possible for the beam shaping optical unit 26 to produce a non-rotationally symmetrical beam profile having a preferred direction, i.e. the beam shaping optical unit 26 acts in the manner of a beam splitter optical unit. Other or more complex beam profiles, e.g. nondiffractive beam profiles such as Airy beam profiles, Mathieu beam profiles, a beam homogenization, the production of a vortex, of a bottle, ..., can also be produced with the aid of the beam shaping optical unit 26. The beam shaping optical unit 26 can be configured as a diffractive optical element, as an axicon, ... or a combination of these elements. The beam shaping optical unit 26 can also be configured as a diffractive optical element having the function of an axicon.

Downstream of the beam shaping optical unit 26 in the present example a beam profile is present which corresponds to a substantially rotationally symmetrical Bessel beam, i.e. to a radial intensity profile in the transverse direction in the form of a Bessel function.

The processing optical unit 16 shown in FIG. 7a additionally comprises an imaging or collimating optical unit 25, which is arranged between the beam shaping optical unit 26 and the polarizer element 1a of the polarizer arrangement 7 in the beam path 10 and which serves for reduced imaging. In FIG. 7a, the far field of the Bessel-like beam profile is present at the position of the polarizer element 1a. The production of a beam profile in the form of a Bessel-like beam has proved to be advantageous for the separation of a workpiece 19 which is produced from a transparent material, for example from glass, and for which separation and, if appropriate, crack guidance along a predefined direction are expedient, which can correspond to the preferred direction X shown in FIGS. 7a,b, but which can also be oriented at a predefined angle with respect to the preferred direction X or, if appropriate, forms a predefined contour deviating from a line. The fact that the longitudinal beam profile of the partial beams 5a, 5b that penetrate into the workpiece 19 proceeds virtually homogeneously over a comparatively long length also facilitates the separation, if appropriate with crack formation, and thus the separating processing of the glass material.

With the aid of a beam splitter optical unit of the processing optical unit 16, said beam splitter optical unit not being illustrated pictorially in FIGS. 7a,b, it is possible to produce a plurality of pairs of focus zones 22a, 22b in the region of the focal plane 18 which are arranged next to one another along the preferred direction X, focus zones 22a, 22b of adjacent partial beams 5a, 5b partly overlapping one another and forming a continuous interaction region 27, which extends along the preferred direction X in the example shown. As has been described further above, the interaction region 27 can also extend along a non-rectilinear contour, which can in particular also extend in the Z-direction into the volume of the workpiece 19. For details of the beam splitting with the aid of the beam splitter optical unit and for details of the transverse and longitudinal beam profiles produced with the aid of the beam shaping optical unit 26, reference should be made to DE 10 2019 205 394.7, cited in the introduction.

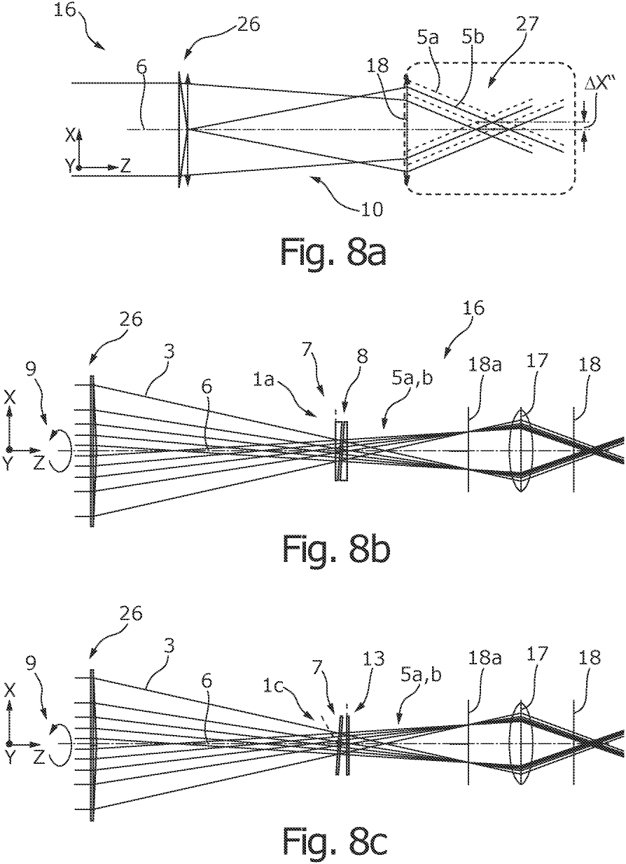

The beam path 10 of the processing optical unit 16 illustrated schematically in FIGS. 7a,b is illustrated in a more realistic way in FIGS. 8a-c. In this case, FIG. 8a shows the beam path 10 without the polarizer device 7, i.e. only the beam shaping optical unit 26, which produces a Bessel-like beam profile from the laser beam 12 entering the processing optical unit 16. For this purpose, the beam shaping optical unit 26 can have a refractive optical element in the form of an axicon, but instead of the axicon a diffractive optical element can also be used as beam shaping optical unit 26. Particularly with the use of a diffractive optical element, it is also possible to produce a Bessel-like beam profile with a preferred direction (X-direction) with a plurality of partial beams 5a,b overlapping one another in pairs (cf. FIGS. 7a,b), i.e. the beam shaping optical unit 26 acts in the manner of a beam splitter optical unit.

FIG. 8b shows the processing optical unit 16 from FIG. 7a, which additionally comprises the polarizer arrangement 7 from FIG. 2a having the polarizer element 1a and the further optically isotropic element 8, which is arranged downstream of the beam shaping optical unit 26 in the beam path 10 and which splits the input laser beam 3 into two partial beams 5a, 5b polarized perpendicularly to one another in order to produce the interaction region 27 extended in a longitudinal direction Z as shown in FIG. 8a. As can be discerned in FIG. 8a, the interaction region 27 has a preferred direction X, along which the two partial beams 5a, 5b or the two focus zones 22a, 22b have a position offset Δx″ with respect to one another.

The processing optical unit 16 shown in FIG. 8c differs from the processing optical unit 16 illustrated in FIG. 8b in terms of the polarizer arrangement 7, which is configured as illustrated in FIG. 3c. The polarizer arrangement 7 comprises a birefringent polarizer element 1c, which produces both a position offset Δx and an angle offset Δα, and also a further birefringent optical element 13.

In FIGS. 8b,c, the focusing optical unit 17 is illustrated merely by way of example as a lens element and generally comprises a plurality of optical elements which together form an objective lens. Besides the front focal plane 18 facing the workpiece 19, the focusing optical unit 17 also has a back focal plane 18a facing the polarizer arrangement 7.

The respective polarizer arrangement 7 of the processing optical units 16 shown in FIGS. 8b,c makes it possible to position one of the two partial beams 5a, 5b on the optical axis 6, but this is not absolutely necessary. As has been described further above, this is advantageous in order to prevent beam wobble if the polarizer arrangement 7 - typically together with the beam shaping optical unit 26 - is rotated about the optical axis 6 of the processing optical unit 16 by means of the rotary drive 9 in order to change (to rotate) the position of the preferred direction in the XY-plane during the processing of the workpiece 19.

Inter alia, a glass cutting or glass separating application, which generally requires high fluences, can be carried out particularly advantageously with the aid of the processing optical unit 16 illustrated in FIGS. 8a-c. In such an application, a laser beam 21 having single pulses or having burst pulses (e.g. 2-6 pulses in the burst with a burst pulse separation of 2 ns to 150 ns, preferably 13 ns to 40 ns) is typically used. The single pulses or the pulses in the burst advantageously have a pulse duration of between 200 fs and 20 ps, in particular between 300 fs and 20 ps, i.e. the laser source 20 is configured as an ultrashort pulse laser source. The pulse energy (total burst or in the single pulse) is preferably between 10 µJ and 10 mJ, in particular between 30 µJ and 1 mJ. The spatial pulse distance or the modification distance between adjacent focus zones 22a, 22b of the interaction region 27 is typically between approximately 0.8 µm and approximately 30 µm.

One major advantage of the processing optical unit 16 shown in FIGS. 8a-c is that the polarizer arrangement 7 can be arranged comparatively far from the back focal plane 18a of the focusing optical unit 17. In the back focal plane 18a of the focusing optical unit 17, the fluences that arise are very high, particularly in the quasi-Bessel case, since a ring focus forms there in this case. By virtue of the comparatively large distance between the polarizer arrangement 7, more precisely the last optical element 8, 13 of the polarizer arrangement 7, and the back focal plane 18a, which distance is typically at least equal to the back focal length of the focusing optical unit 17, damage to the polarizer arrangement 7 as a result of excessively high fluences can generally be avoided. In addition, the back focal plane 18a does not have good mechanical accessibility, particularly in the case of short focal lengths of the focusing optical unit 17.

Depending on the application, it may be expedient to produce left and respectively right circularly polarized partial beams 5a, 5b instead of linearly polarized partial beams 5a, 5b in the focal plane 18. For this purpose, a retardation element, e.g. in the form of a λ/4 plate, can be arranged at a suitable location downstream of the polarizer arrangement 7 in the beam path 10.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A processing optical unit for workpiece processing, comprising:
a polarizer arrangement comprising a birefringent polarizer element for splitting at least one input laser beam into at least two partial beams each partial beam having one of two different polarization states; and
a focusing optical unit arranged downstream of the polarizer arrangement in the beam path and configured to focus the partial beams onto at least two focus zones,
wherein the polarizer arrangement has a further optical element arranged downstream of the birefringent polarizer element in the beam path and configured to change an angle and/or a distance of at least one of the partial beams relative to an optical axis of the processing optical unit.

2. The processing optical unit as claimed in claim 1, wherein the polarizer element is configured to produce a position offset and/or an angle offset between the partial beams having the different polarization states.

3. The processing optical unit as claimed in claim 2, wherein the polarizer element is configured to produce an angle offset between the partial beams having the different polarization states, and wherein the further optical element is configured to change the angle of one of the two partial beams relative to the optical axis in order to align the partial beam parallel to the optical axis.

4. The processing optical unit as claimed in claim 3, wherein the further optical element is configured in an optically isotropic fashion, wherein the polarizer element is configured to produce an angle offset without producing a position offset.

5. The processing optical unit as claimed in claim 3, wherein the polarizer arrangement has a beam offset optical unit having a further birefringent element configured to align both partial beams parallel to one another.

6. The processing optical unit as claimed in claim 3, wherein the polarizer arrangement is configured to position one of the partial beams on the optical axis or to position both partial beams at identical distances from the optical axis.

7. The processing optical unit as claimed in claim 6, wherein the birefringent polarizer element is configured to produce a position offset in addition to producing the angle offset, and wherein the further optical element is configured in a birefringent fashion to position the partial beam on the optical axis.

8. The processing optical unit as claimed in claim 2, wherein the polarizer arrangement is configured to change an angle offset and/or a position offset between the two partial beams.

9. The processing optical unit as claimed in claim 8, wherein the further optical element is configured in a birefringent fashion and, for the purpose of changing the angle offset is displaceable along the optical axis of the processing optical unit and/or is rotatable about the optical axis of the processing optical unit.

10. The processing optical unit as claimed in claim 1, wherein the further optical element is configured in a birefringent fashion, and wherein a polarization-influencing optical element is arranged upstream of the further optical element.

11. The processing optical unit as claimed in claim 1, further comprising: a beam shaping optical unit configured to convert an entering laser beam having a Gaussian beam profile into an emerging laser beam having a quasi-nondiffractive beam profile.

12. The processing optical unit as claimed in claim 11, wherein the beam shaping optical unit is configured for producing a non-rotationally symmetrical quasi-nondiffractive beam profile.

13. The processing optical unit as claimed in claim 1, wherein the at least two focus zones are at least partly overlapping focus zones of a continuous interaction region, wherein the partial beams each have different polarization states .

14. The processing optical unit as claimed in claim 1, further comprising a rotary drive configured to rotate the polarizer arrangement and/or the beam shaping optical unit about a rotation axis.

15. A laser processing apparatus, comprising:
a processing optical unit as claimed in claim 1,
and a laser source.

16. A method for the laser processing of a workpiece using a processing optical unit, comprising:
splitting at least one input laser beam into at least two partial beams, each having one of two different polarization states, at a birefringent polarizer element of a polarizer arrangement, and
focusing the partial beams onto focus zones in a region of the workpiece using a focusing device of the processing optical unit, and
changing an angle and/or a distance of at least one of the partial beams relative to an optical axis of the processing optical unit at at least one further optical element of the polarizer arrangement arranged downstream of the birefringent polarizer element in the beam path.

17. The processing optical unit as claimed in claim 11, wherein the quasi-nondiffractive beam profile includes a Bessel-like beam profile.
